(19) United States
(12) Patent Application Publication
(10) Pub. No.: US 2022/0385161 A1
(43) Pub. Date: Dec. 1, 2022

(54) FOUR MAGNET MOTOR STRUCTURE FOR A SPEAKER

(71) Applicant: Resonado, Inc., Chicago, IL (US)

(72) Inventors: Paul Joseph VEDIER, Chicago, IL (US); Benny Lee DANOVI, Jackson, MI (US)

(21) Appl. No.: 17/829,705

(22) Filed: Jun. 1, 2022

Related U.S. Application Data
(60) Provisional application No. 63/195,355, filed on Jun. 1, 2021.

(51) Int. Cl. H02K 41/035; H04R 9/02; H04R 9/06

(52) U.S. Cl. CPC H02K 41/0356; H04R 9/025; H04R 9/06

(57) ABSTRACT

An embodiment of a motor for a speaker is disclosed. The motor comprises a first assembly comprising a first magnet, a second magnet, and a first plate between the first magnet and the second magnet; a second assembly; and a voice coil structure located between the first assembly and the second assembly.

### PRIORITY CLAIM

This application claims priority to U.S. Provisional Patent Application No. 63/195,355, filed on Jun. 1, 2021, and titled, “Improved Speaker System,” which is incorporated by reference herein.

### TECHNICAL FIELD

An embodiment is disclosed of a motor for a speaker. The embodiment comprises four magnets and a voice coil structure.

### BACKGROUND OF THE INVENTION

Prior art speakers typically comprise a set of plates and magnets that generate a magnetic field that interacts with a voice coil. The voice coil receives an electrical audio signal. The current in the voice coil generates a magnetic field that interacts with the magnetic field generated by the plates and magnets, resulting in the voice coil and the structure that holds the voice coil to physically move up or down. This movement in turn creates vibrations in a diaphragm, which results in sound emanating from the speaker.

FIG. 1 depicts prior art motor 100 used in a speaker. Motor comprises magnet 101 between plates 102 and 103, magnet 104 between plates 105 and 106, and voice coil 107. The amount of force that can be generated by motor 100 is related to the amount of voice coil wire present in voice coil 107.

What is needed is a motor that can generate greater force than prior art motor 100 using a similar amount of space. What is further needed is a motor that is cheaper to manufacture than prior art motor 100.

### SUMMARY OF THE INVENTION

An embodiment is disclosed of a speaker comprising a first set of magnets separated by a first plate, a second set of magnets separated by a second plate, and a voice coil positioned between the first set of magnets and the second set of magnets to drive one or more diaphragms of a speaker.

### BRIEF DESCRIPTION OF THE DRAWINGS

FIG. 1 depicts a prior art motor for use in a speaker.

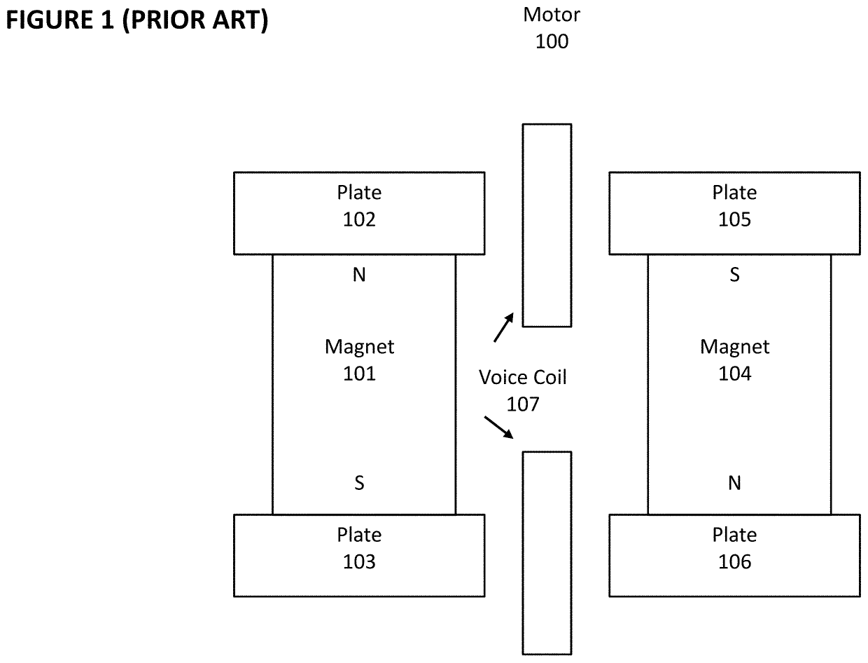

FIG. 2 depicts a motor for use in a speaker.

FIG. 3 depicts another motor for use in a speaker.

FIG. 4 depicts a speaker containing the motor of FIG. 2.

FIG. 5 depicts a speaker containing the motor of FIG. 3.

### DETAILED DESCRIPTION OF THE PREFERRED EMBODIMENT

Features and advantages of the present invention described above will become apparent from the following descriptions in conjunction with the accompanying drawings. According to the descriptions, a person with the proper technical expertise will be able to execute the technical idea illustrated in this present invention in the relevant industry. Since this invention can have a variety of different applications and may take different forms and shapes, only specific examples are illustrated through Figures and the detailed descriptions are found in the main text. However, this is by no means to restrict the present invention to the particular form disclosed; its derivations, equivalents, and substitutes must be understood as embracing all included in the scope of the present invention. The terms used herein are merely used to describe particular examples and are not intended to limit the present invention.

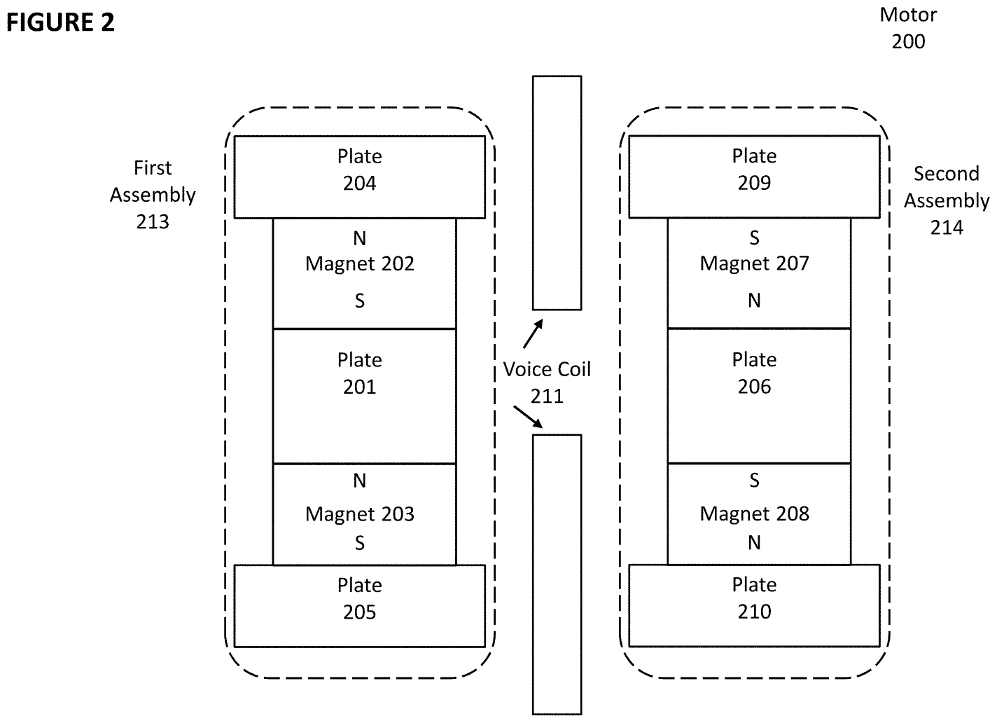

FIG. 2 depicts motor 200 used in a speaker. Motor 200 comprises first assembly 213 and second assembly 214. First assembly 213 comprises magnets 202 and 203 separated by plate 201, top plate 204, and bottom plate 205. Second assembly 214 comprises magnets 207 and 208 separated by plate 206, top plate 209, and bottom plate 210. Motor 200 further comprises voice coil 211 positioned between first assembly 213 and second assembly 214.

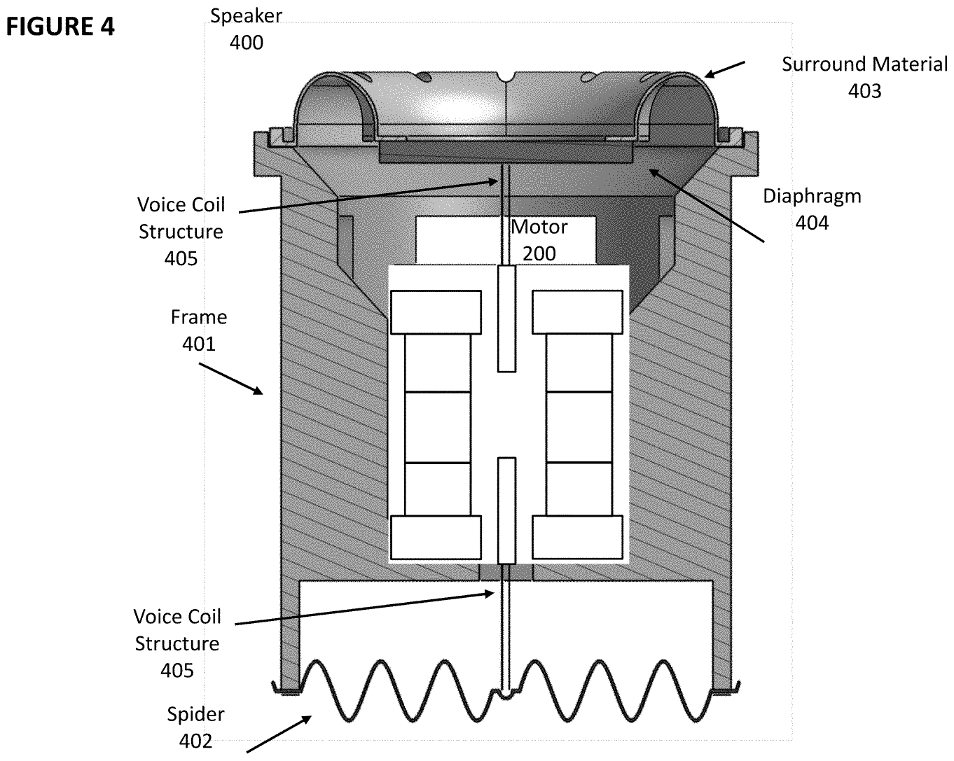

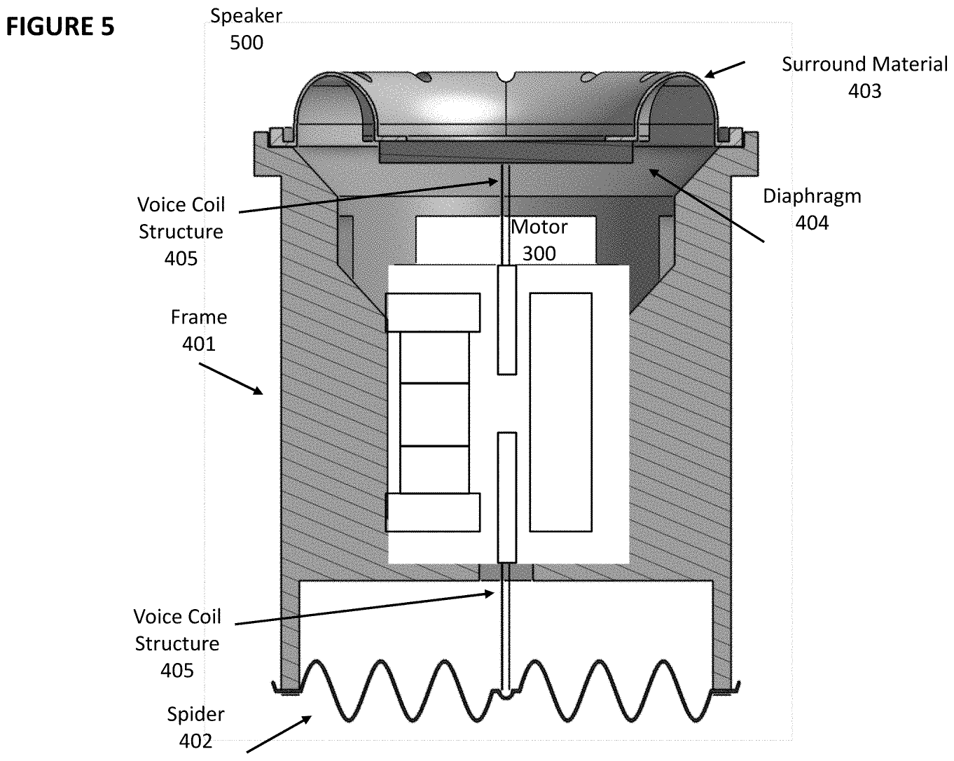

Voice coil 211 may comprise any electrically-conductive material, including but not limited to, any variant of copper wire, printed circuit board, flexible printed circuit board, or other conductive metal or alloy. Voice coil 211 is attached to a voice coil structure (not shown here, but shown in FIGS. 4 and 5), such as a plate, bobbin, printed circuit board (PCB), or other structure. Voice coil 211 receives an electrical audio signal from a signal source (not shown), and current through voice coil 211 generates a magnetic field.

A magnetic field is induced by magnets 202, 203, 207, and 208, generally in the direction from the north poles (N) to the south poles (S). Here, magnets 202 and 203 in first assembly 213 and magnets 207 and 208 in second assembly 214 are oriented in opposite directions. Lorentz forces are generated by voice coil 211 interacting with the magnetic field generated by magnets 202, 203, 207, and 208, which pushes the voice coil structure (such as voice coil structure 405 in FIGS. 5 and 6)containing voice coil 211 upward or downward, which pushes a diaphragm (shown in FIGS. 4 and 5 as diaphragm 404) upward or downward, respectively, according to the magnitude of the electrical signal(s) from the signal source(s).

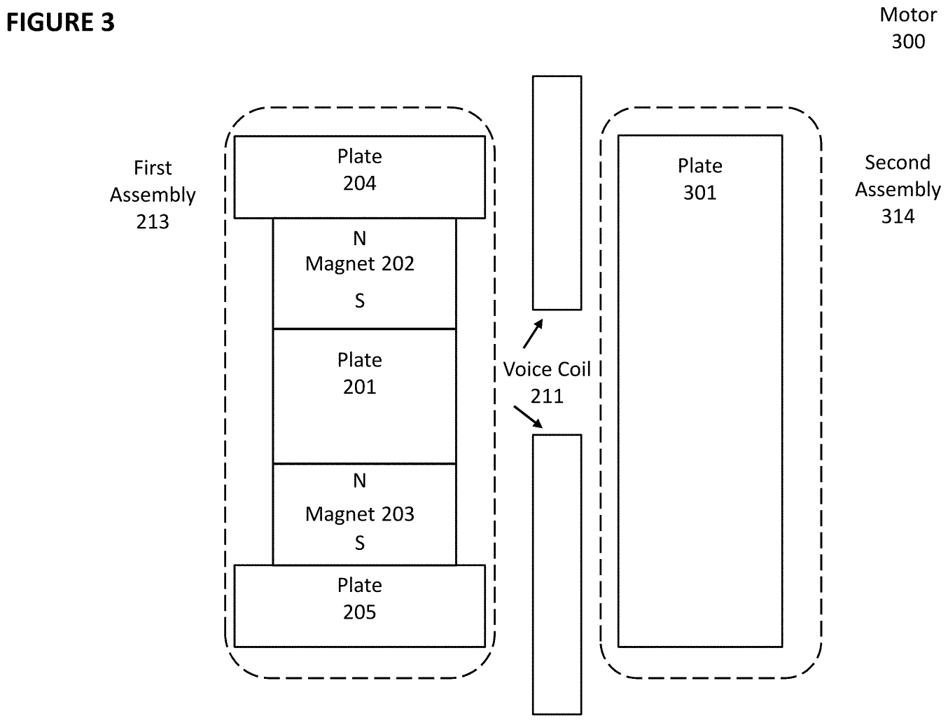

FIG. 3 depicts motor 300. Motor 300 comprises first assembly 213, which is identical to first assembly 213 in motor 200 in FIG. 2. However, motor 300 comprises second assembly 314, which here comprises plate 301, which is an alternative to second assembly 214 in FIG. 2. Motor 300 operates in a similar manner to motor 200 but will be cheaper to manufacture since magnets typically are more expensive than plates.

FIG. 4 depicts speaker 400. Speaker 400 comprises motor 200, frame 401, spider 402, surround material 403, diaphragm 404, and voice coil structure 405.

The voice coil structure in motor 200 interacts with diaphragm 404 to generate sound. Diaphragm 404 will be vibrated at a specific frequency range by the magnetic field induced by magnets 202, 203, 207, and 208 and the electric current flowing in voice coil 211. Diaphragm 404 is coupled to frame 401 through surround material 403. Surround material 403 comprises a flexible material such as rubber. The other end of motor 200 is coupled to frame 401 through spider 402. The voice coil is driven by a signal source (not shown).

FIG. 5 depicts speaker 500. Speaker 500 is identical to speaker 400 except that it comprises motor 300 instead of motor 200. Speaker 500 otherwise operates in the same manner as speaker 400.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A motor for a speaker comprising:
a first assembly comprising a first magnet, a second magnet, and a first plate between the first magnet and the second magnet;
a second assembly; and
a voice coil structure located between the first assembly and the second assembly.

2. The motor of claim 1, wherein the second assembly comprises a second plate.

3. The motor of claim 2, wherein the first assembly further comprises a third plate on top of the first magnet and a fifth plate on the bottom of the second magnet.

4. The motor of claim 1, wherein the second assembly comprises a third magnet, a fourth magnet, and a second plate between the third magnet and the fourth magnet.

5. The motor of claim 4, wherein the first assembly further comprises a third plate on top of the first magnet and a fourth plate on the bottom of the second magnet.

6. The motor of claim 5, wherein the second assembly further comprises a fifth plate on top of the third magnet and a sixth plate on the bottom of the fourth magnet.

7. A speaker comprising:
a first assembly comprising a first magnet, a second magnet, and a first plate between the first magnet and the second magnet;
a second assembly;
a voice coil structure located between the first assembly and the second assembly; and
a diaphragm connected to the voice coil structure to generate sound.

8. The speaker of claim 7, wherein the second assembly comprises a second plate.

9. The speaker of claim 8, wherein the first assembly further comprises a third plate on top of the first magnet and a fifth plate on the bottom of the second magnet.

10. The speaker of claim 8, further comprising a frame, wherein the first assembly and the second assembly are contained in the frame.

11. The speaker of claim 10, further comprising surround material over the diaphragm and coupled to the frame.

12. The speaker of claim 11, further comprising a spider under the first assembly and the second assembly and coupled to the frame.

13. The speaker of claim 7, wherein the second assembly comprises a third magnet, a fourth magnet, and a second plate between the third magnet and the fourth magnet.

14. The speaker of claim 13, wherein the first assembly further comprises a third plate on top of the first magnet and a fourth plate on the bottom of the second magnet.

15. The speaker of claim 14, wherein the second assembly further comprises a fifth plate on top of the third magnet and a sixth plate on the bottom of the fourth magnet.

16. The speaker of claim 13, further comprising a frame, wherein the first assembly and the second assembly are contained in the frame.

17. The speaker of claim 16, further comprising surround material over the diaphragm and coupled to the frame.

18. The speaker of claim 17, further comprising a spider under the first assembly and the second assembly and coupled to the frame.
